(19) United States
(12) Patent Application Publication
(10) Pub. No.: US 2008/0052641 A1
(43) Pub. Date: Feb. 28, 2008

(54) System and method for secure and private media management

(75) Inventors: David Brown, San Francisco, CA (US); Robert Lord, San Francisco, CA (US)

Correspondence Address: FOLEY AND LARDNER LLP;SUITE 500, 3000 K STREET NW, WASHINGTON, DC, 20007, US

(73) Assignee: Sun River Systems, Inc.

(21) Appl. No.: 11/819,081

(22) Filed: Jun. 25, 2007

Related U.S. Application Data
(60) Provisional application No. 60/816,321, filed on Jun. 26, 2006.

(51) Int. Cl. G06F 3/048

(52) U.S. Cl. 715/811

(57) ABSTRACT

In a system and method for the secure and private management of media, a software application utilizes a database to store encrypted persistent data files along with information to encrypt and decrypt media files which are associated with the software application.

This application claims priority to and benefit of U.S. Provisional Application No. 60/816,321, filed Jun. 26, 2006, the disclosure of which is incorporated herein by reference in its entirety

### FIELD OF THE INVENTION

The present invention relates generally to viewing media files through a single software application. More specifically, the present invention relates to a method for managing and viewing media files securely and privately through a single software application.

### BACKGROUND OF THE INVENTION

Conventionally, users of personal computer software find, store, and view media files in a candid and non-private fashion. The traditional methods of finding, storing, and viewing media files are such that any user's previous activity may be discovered by individuals of modest skill in computer technology. As a result, the user of a personal computer forfeits the ability to control information related to the their previous activity.

In particular, users who search for, browse, and view media files via an Internet web browser will have difficulty doing so in a private fashion with traditional technologies. Traditional web browsing and downloading technologies result in the local storage of unencrypted media files. In addition, web browser software maintains a history of visited sites and cookies, which creates an electronic trail detailing the previous activity of the user. Lastly, many websites spawn annoying and dangerous popup windows which may infect computers with viruses and malware.

### SUMMARY OF THE INVENTION

Briefly, a method consistent with the present invention for securely and privately accessing media files in a single software application includes a software application which exclusively stores all files detailing a user's activity in a database.

In another aspect of the invention, files detailing the user's activity are encrypted prior to their storage, and decrypted prior to their use.

In yet another aspect of the invention, media files which are associated with the software application are partially encrypted prior to their storage.

In yet another aspect of the invention, a unique key for each user of the software application is stored in a database and used for the encryption of media files that are associated with the application.

In yet another aspect of the invention, the software application allows users to download an entire web page's content with a single click of a mouse input device, or individual media files with a single click of a mouse input device.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a block diagram of a secure media file management system consistent with the present invention.

FIG. 2 is a flow diagram of a method for the protection of persistent data files of the media file management system during start up.

FIG. 3 is a flow diagram of a method for the protection of persistent data files of the media file management system which are added while the media file management system is running.

FIG. 4 is a flow diagram of a method for the protection of persistent data files during the shut down procedures of the media file management system.

FIG. 5 is a flow diagram of a method for one mouse click downloading of all media files displayed in the browsing window of the media file management system.

FIGS. 6A and 6B are flow diagrams of a method for a single mouse click downloading of an individual media file displayed in the browsing window of the media file management system.

FIG. 7 is a flow diagram of a method for the encryption and storage of media files.

FIG. 8 is a flow diagram of a method for the decryption of media files.

FIG. 9 is a flow diagram of a method for the importing and encrypting of media files.

FIGS. 10A-10C are diagrams illustrating the user actions for the one click download of a single media file and one click download of an entire displayed page's content.

FIGS. 11A-11D are diagrams illustrating a panic mode for the media file management system, and the ability to obscure the media file management system's identity through icon renaming.

### DETAILED DESCRIPTION

The present invention will be described in the context of a specific embodiment, but the invention is not intended to be so limited.

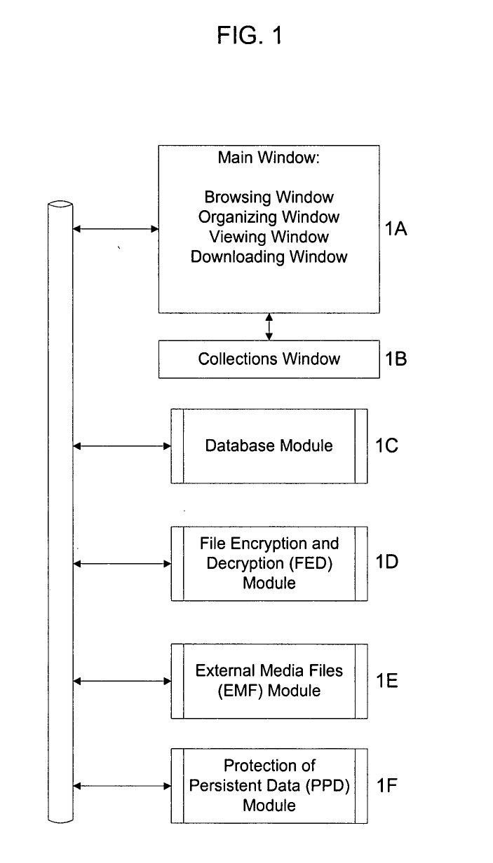

FIG. 1 is a block diagram of a media file management system consistent with the present invention. The media file management system is preferably configured as an integrated software application, although it is possible for various modules of the media file management system to be independent applications that coordinate with each other or be implemented as plug-ins to a base software application. As shown in FIG. 1, the media file management system includes a main window 1A, a collections window 1B, a database module 1C, a file encryption and decryption module 1D, an external media files module 1E, and a protection of persistent data module 1F. The main window 1A is preferably configured to display one of four graphical windows that interact together and with internal modules in order to give the software its features and utility. The four graphical windows include a browsing window, an organizing window, a viewing window, and a downloading window.

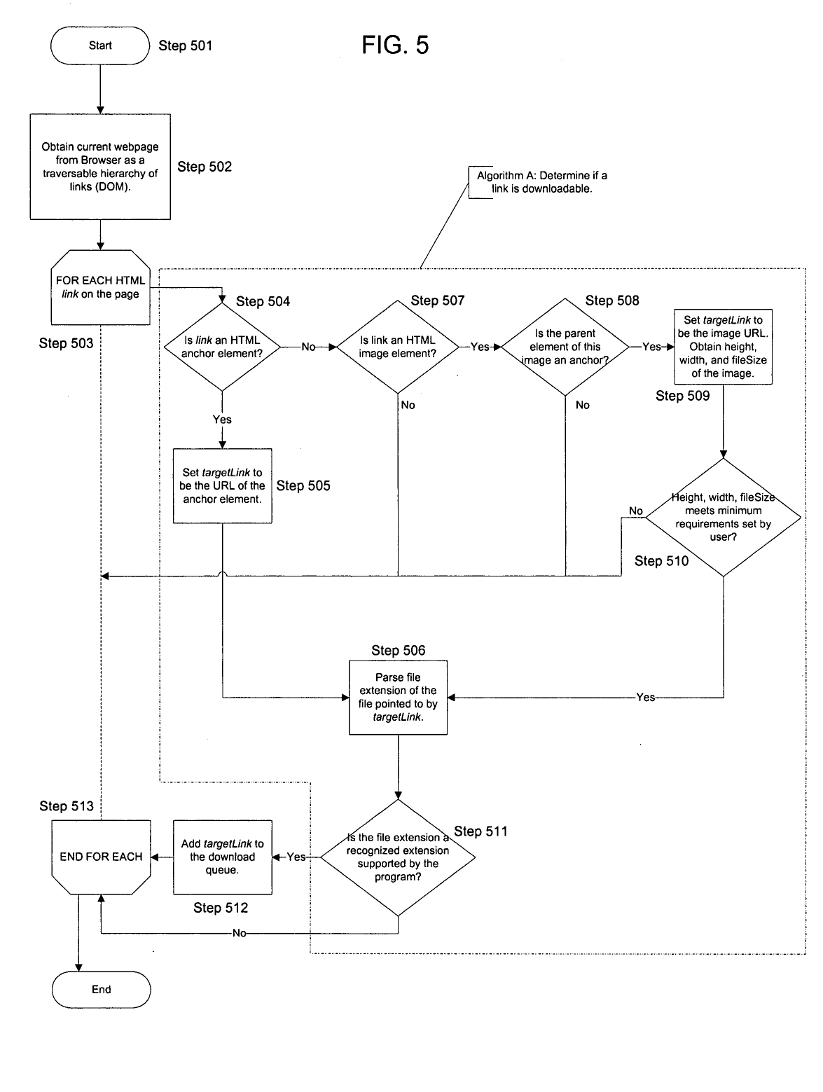

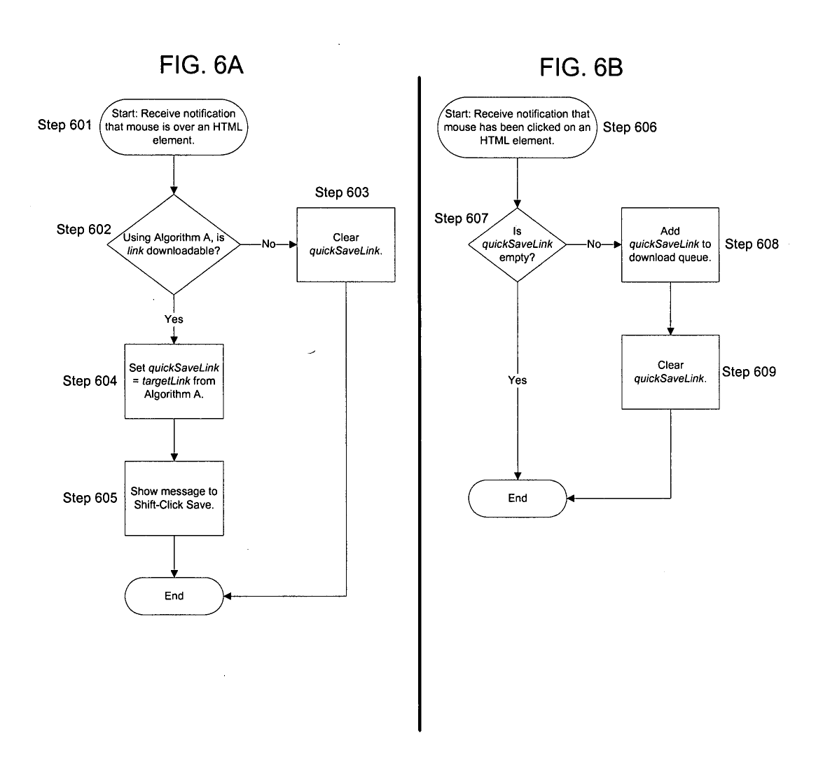

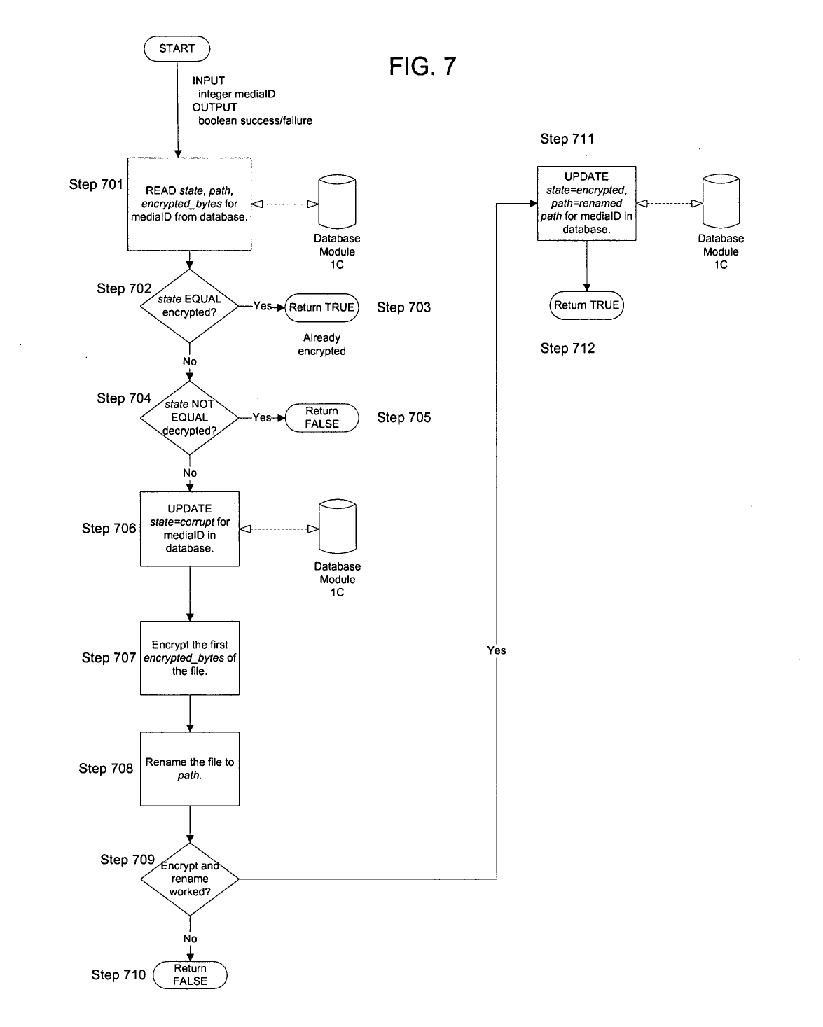

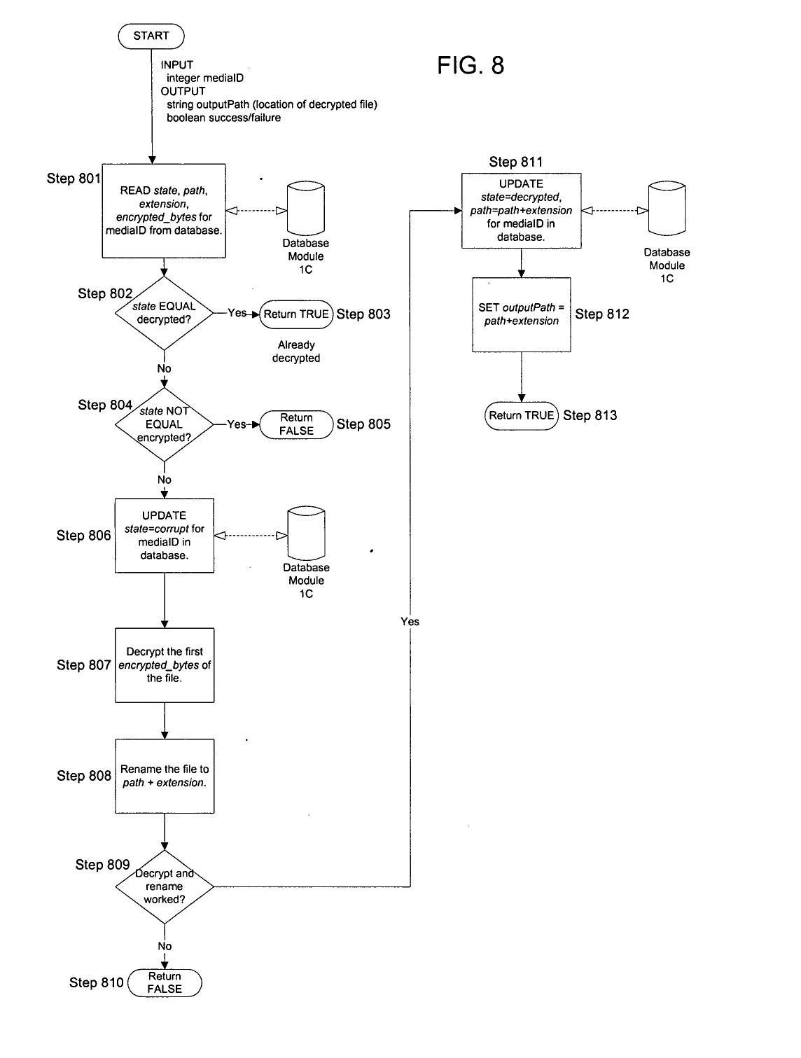

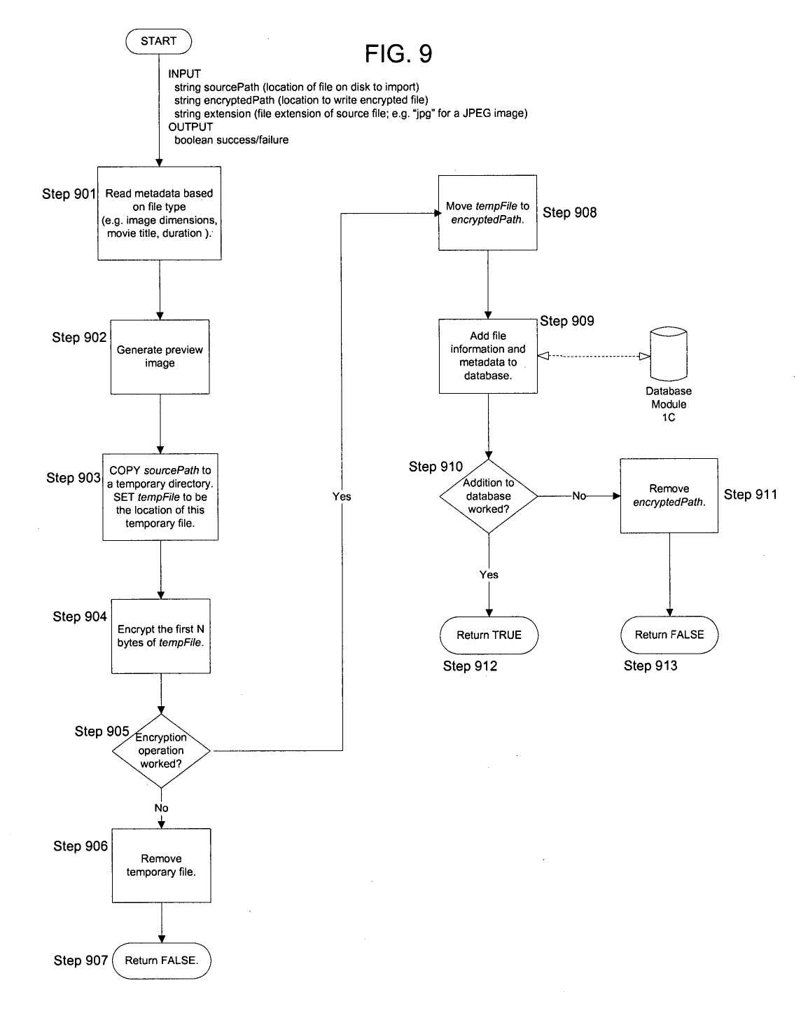

The browsing window of the main window 1A is configured to allow the user to view sources for media files. For example, the browsing window could allow the user to view Internet web pages. While viewing Internet web pages, the user may download all the media content on the current web page (see FIG. 5), or download individual items of content (see FIG. 6). Media files that are downloaded are associated with the media file management system so that users can later view the downloaded media files. Media files that are associated with the media file management system can be encrypted as described in FIG. 7, decrypted as described in FIG. 8, imported as described in FIG. 9, and downloaded as described in FIGS. 5 and 6. Media files are typically associated with the media file management system through actions of the user, and preferably are not provided directly by the media file management system.

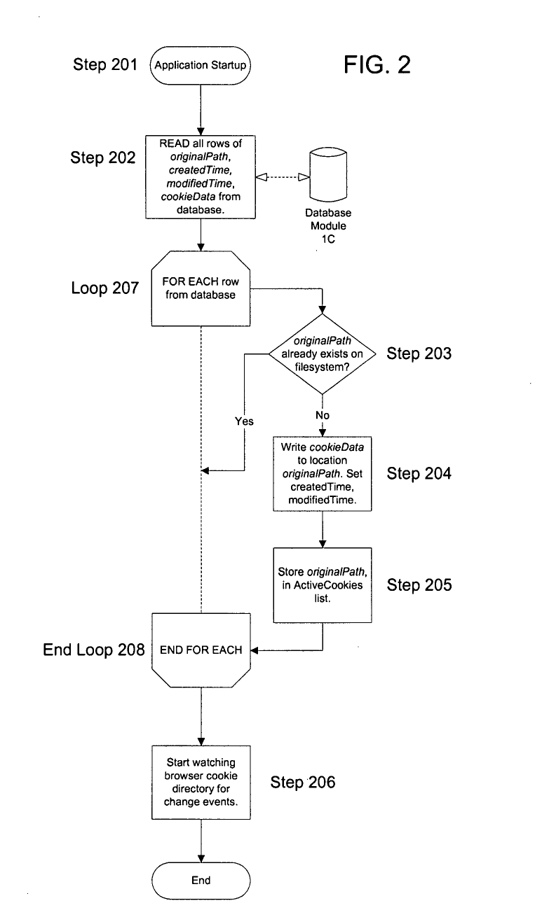

The browsing window can be configured to prevent popup web pages from spawning and to allow users to designate certain web pages as favorites. For example, a screenshot of the favorite can be created from the visual content currently displayed in the browsing window, and the image is added to the media files associated with the media file management system. The user may later revisit the favorite by selecting the screenshot of the favorite in the viewing window. Additionally, the browsing window can be configured to protect the user's browsing activity by utilizing an encrypted database for Internet web page cookies and other persistent data files used by the media file management system. Examples of other persistent data files used by the media file management system would be a user's history of visited web sites, preferences, or other runtime settings of the software application. FIGS. 2, 3, and 4 illustrate the method by which a particular type of persistent data file, the software application's Internet web page cookies, are protected.

The second of the four graphical windows in the main window 1A is the organizing window. The organizing window is preferably configured to organize the media files associated with the media file management system in any of multiple ways. For example, the media files can be organized in a thumbnail view. The thumbnail view automatically organizes all preview images in a grid. The thumbnail view presents media files as small thumbnail preview images of the actual file. For example, a movie file may have a thumbnail view which is a snapshot of the movie at a certain time during playback. The media files can also be organized in a list view. This view allows the user to sort the database of stored media files according to several criteria. For example, lists of database stored media files could be sorted by alphabetical title, or type of media file (movie or image). In either the thumbnail or list type of organization, or other type of organization as are known in the art, the organizing window is configured to allow the user to drag, drop, copy, move, or play the stored media files that are displayed. Additionally, collections (e.g., of media files) may be viewed in the organizing window. Media files of a collection are displayed sequentially in the play order in which they are organized.

The third of the four graphical windows of the main window A1 is the viewing window. The viewing window is configured to allow the user to view the media files associated with the software application. For images, the user is able to see the full-size image, zoom in/out, pan and scroll the image, and resize the image. For movies, the user is able to play/pause/seek the movie. Additionally, for movies, the user may create video bookmarks for each movie file. A video bookmark is a specific location in a video file that the user can immediately skip to whenever the movie is played. Video bookmarks may be named and renamed by the user in order to more accurately describe the particular location in the movie that the video bookmark represents. Additionally, video bookmarks can be graphically displayed when the movie is played by depicting the video bookmark's location in time on a timeline of the movie, which can be referred to as the seek bar. Video bookmarks are considered persistent data, and are preferably encrypted and stored in the database module 1C in the same fashion as Internet web page cookies.

The viewing window also shows the preview images of all the media files that the user has queued to play. The previews of the media files are shown in the order the files are to be played. Video bookmarks of movie files are displayed along side the preview image of the corresponding movie file contained in the viewing window. The user may rearrange the playback order of the queue of media files to be played at any time by dragging and dropping the preview images of each individual media file.

The fourth of four windows in the main window 1A is the downloading window. The downloading window is configured to allow the user to view all the media files that are queued to be downloaded. Relevant information is displayed so the user may gauge the progress of current downloads. For example, examples of relevant information are total file size, estimated download time, current percentage downloaded, and final destination. Media files are added to the downloading window through user actions conducted in the browsing window. For example, a user can select to download all the media contained on a single web page (see FIG. 5). Items that are displayed in the downloading window may be cancelled, retried, or cleared by the user.

The collections window 1B, which is preferably configured to be viewable at all times, displays one or more playlists of media files. A collection is a list of media files grouped together by the user that can be played in the viewing window of the main window 1A when selected to be played. The user may place any number of media files at any place into a collection, and the same media file may appear multiple times within the same collection. The user may create any number of collections, all of which are displayed in the collections window 1B. A collection is played in the viewing window in the order in which it is organized. Alternatively, the media files in the collection can be played in the viewing window in a random order. Collections can be organized by moving media files from the organizing window into a collection, or by specifying a collection as the final destination of a download. Media files from the organizing window may be copied or moved, such as by dragging and dropping, into any of the collections. Entire collections may be played in the viewing window. When media files contained in a collection are played sequentially, the order in which media files of a collection are played is typically the same order displayed when the collection is displayed in the organizing window.

Each of the windows listed above interact with internal modules to create the a secure and private method of media management using the media file management system. These modules include the database module 1C, the file encryption and decryption (FED) module 1D, the external media files (EMF) module 1E, and the protection and persistent data (PPD) module 1F.

The Database Module 1C comprises an organized storage system for data. An example of an organized storage system for data would be a relational database system. All relevant information to the media file management system is stored in the database module 1C. Examples of relevant information stored in the database module 1C are Internet web browser cookies and other persistent data files, along with information necessary to encrypt and decrypt media files associated with the media file management system. All information stored in the database module 1C is preferably encrypted using secret keys. Each individual user of the media file management system is preferably provided with a unique key which is unknown to other users. The encryption of information relevant to the media file management system guarantees that only those who know the secret key are able to access the data contained in those files. The secret key used for encryption of the files can be made available to the media file management system through the database module 1C.

The FED Module 1D controls the encryption and decryption of all relevant files and information associated with the media file management system. After encryption, the FED module 1D stores the path to the encrypted media file into the database module 1C. Information about how to encrypt and decrypt these files is also stored in the database module 1C. Media files which are to be viewed in the viewing window are retrieved from the path at which they are stored, and the files are decrypted by the FED module 1D using information in the database module 1D. Once the file has been viewed, a portion of the decrypted file can be re-encrypted to maintain security. FIGS. 7 and 8 detail the encryption and decryption methods for media files.

The EMF module 1E enables a media file currently stored in another location to be associated with the media file management system. For example, a user may have a collection of media that the user wishes to associate with the media file management system that is stored on the hard disk drive of the user's computer. Media files imported by the EMF module 1E are encrypted by the FED module 1D. Once imported, the imported media files are treated by the media file management system in the same way as those files which are already associated with the media file management system.

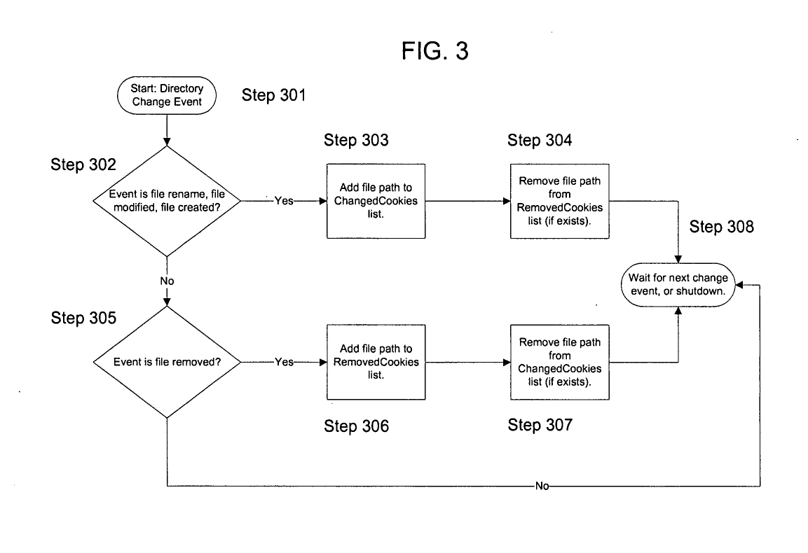

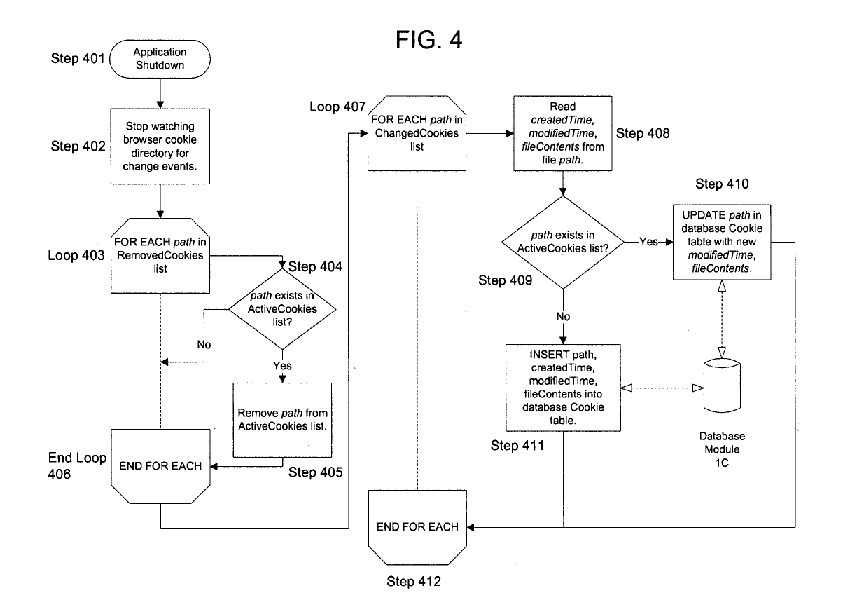

The PPD module 1F protects persistent data files, which indicate, for example, preferences of the user, runtime settings, and an electronic trail of the user's activity produced by the media file management system. For example, the media file management system can use and store Internet web browser cookies and history data files indicating the previous activity of the user. All of these data files are encrypted by the PPD module 1F and stored in the database module 1C. When the media file management system is started, the data files are read from the database module 1C and replaced so that they may be used by the browsing window in main window 1A. When the media file management system is closed, the data files are removed from the media file management system's tracking system and stored in the database module 1C (see FIG. 3). Lastly, when data files are written during use of the browsing window, those cookies will be encrypted and added to the database module 1C upon shutdown (see FIG. 4).

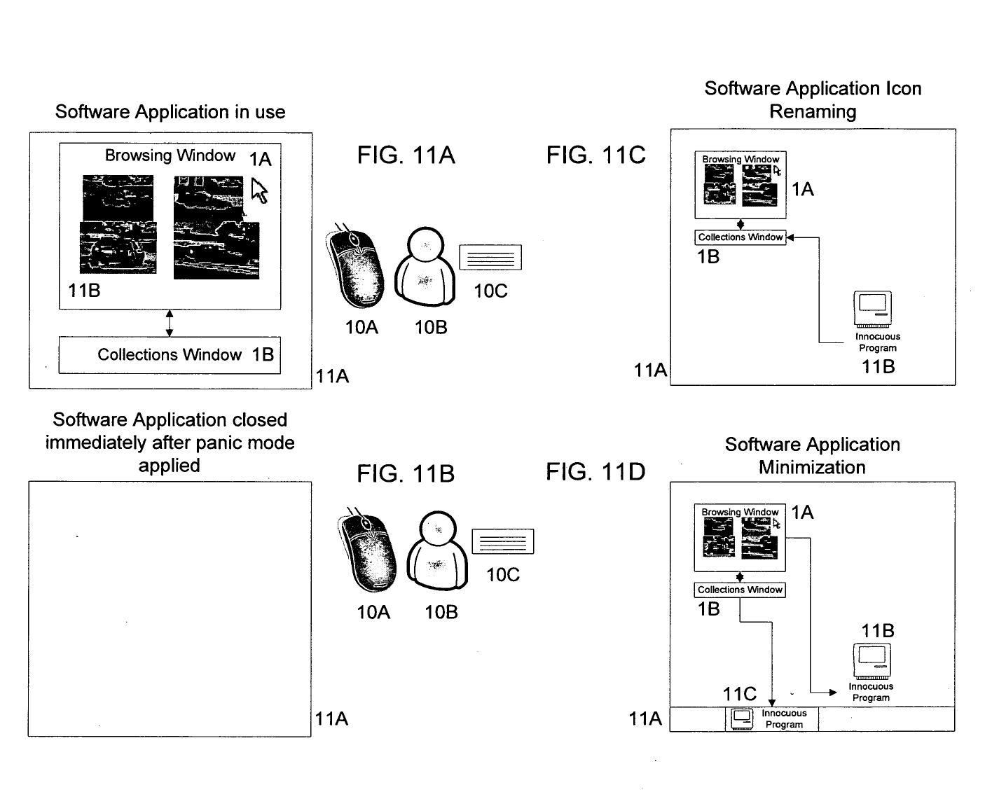

As a matter of general security, access to the media file management system is designed to prevent unauthorized use. The media file management system can be configured to require a user login password upon start up and also when the program is restored from the minimized state. In addition, the media file management system may be minimized in a way to obfuscate its identity. For example, the media file management system's icon and title can be changed to represent another innocuous program (see FIG. 11). In addition, the media file management system also has a panic mode, which allows the user to either instantly close or minimize the program by inputting a pre-determined input sequence. For example, the user could designate a single escape key input that would trigger the program to go into panic mode (see FIG. 11). During use of the browsing window, the media file management system is preferably designed to prevent spawning of other browsing windows during the user's use of the program.

FIGS. 11A-11D are diagrams illustrating a panic mode for the media file management system, and the ability to obscure the media file management system's identity through icon renaming. FIG. 11A represents the visual output device for the computer on which the media file management system is executing on a display 11A. As shown in FIG. 11A, the media file management system has the browsing window open in main window 1A and the collections window 1B open. While the media file management system is running, a user 10B may input a predetermined key sequence through keyboard 10C or a mouse input sequence through 10A that will cause the media file management system to enter a panic mode. The result of the entry of the media file management system into panic mode is shown in FIG. 11B. In particular, when entering the panic mode, the media file management system immediately closes, and there is no evidence on the display 11A that software application had been running.

Further, FIG. 11C represents the visual output on the display 11A of a computer on which the media file management system is executed after the user 10B has initiated the application through the use of a program icon 11B. The program icon 11B can be custom labeled by the user 10B, and the icon 11B can be chosen to allow the user to obscure the identity of the media file management system. In addition, as shown in FIG. 11D, while the media file management system is running, the user 10B can minimize the application down into the program icon 11B or into a task bar icon 11C of the windowing system on the display 11A. The user 10B has the ability to choose a custom label for the task bar icon 11C and program icon 11B, allowing the user 10B to obscure the identity of the media file management system while it is executing.

FIGS. 2, 3, and 4 are block diagrams showing methods for the protection and maintenance of persistent data files in the media file management system of FIG. 1. The persistent data files of the media file management system indicate the previous activity of the user (e.g., access history), the user's preferences, and other runtime settings. An example of a persistent data file protected by the media file management system is an Internet web browser cookie. An internet web browser cookie is a small segment of text sent by a web server to a web browser. Internet web browser cookies are recorded by the web browser, and subsequently sent to the original sender web server each time the web browser requests information from or visits that web server. Web browser cookies are used for tracking, authenticating, and maintaining specific information about users of web services.

FIG. 2 is a flow diagram of the method for the protection of persistent data files of the media file management system during start up. The method of FIG. 2 can be implemented with PPD module 1F to protect and secure the persistent data files, such as Internet web browser cookies, that are produced and used by the media file management system. Although the method of FIG. 2 is directed to Internet web browser cookies, it should be understood that the method is applicable to other persistent data files of the media file management system. First the application, i.e., the media file management system, is started up (step 201). After startup, the PPD module 1F reads the entire record set representing all the web browser cookies stored in the database module 1C. Each individual record represents a single web browser cookie. Loop 207 is a logical looping structure that is designed to iterate through the entire record set made available to the PPD module 1F during step 202. While in loop 207, the PPD module 1F determines if the record in question (an individual web browser cookie) is already available directly to the media file management system (step 203). If the individual web browser cookie in question is not available to the media file management system directly, the record is made available to the media file management system by writing the record to the applicable location (step 204) and storing that location in an ActiveCookies list (step 205). The ActiveCookies list represents those cookies which were not directly available to the media file management system, but were stored in the database module 1C. These cookies are active because they may be modified during the execution of the PPD module 1F.

Once all of the records have been analyzed, the loop ends (end loop 208). Following the start up of the media file management system, the PPD module 1F is designed to monitor when a web browser cookie event occurs within the media file management system (step 206). For example, a web browser cookie event would occur when a new cookie is created in the media file management system upon visiting a new web server.

FIG. 3 is a flow diagram of the method for the protection of persistent data files of the media file management system that are added while the software application is running. Like the method of FIG. 2, the method of FIG. 3 can also be implemented by PPD module 1F to protect and secure the Internet web browser cookies, and other persistent data files, that are produced and used by the media file management system. As shown in FIG. 3, a directory change event occurs, which is handled by an interrupt handler, as distinct from a polling method, which occurs when a new web browser event occurs (step 301). An example of a web browser cookie event would be when a new cookie is created in the media file management system upon visiting a new web server. A directory change event occurs if, for example, a web browser cookie event modified an existing web browser cookie or created a new cookie.

A determination is made if the event is the renaming, modification or creation of a file or cookie (step 302). If so, the file or cookie that was the subject of the event is added to a list of designated ChangedCookies or other type of change persistent data file (step 303). The ChangedCookies list represents those web browser cookies which have been created or modified. In addition, the modified cookie is removed from a list designated RemovedCookies if the modified cookie is part of the RemovedCookies list (step 304). The RemovedCookies list's function is more fully described below. The interrupt handler method then proceeds to a wait state in anticipation of another event change or shutdown of the media file management system (step 308). If a web browser cookie event occurs, that event is serviced beginning at step 301. If the software application is shutdown, the event is handled by the PPD module 1F as indicated in FIG. 4.

If the event is not a renaming, modification, or creation of a file or cookie, a determination is made to see if the event is the removal of a file or cookie (step 305). If not, the PPD module 1F proceeds to the wait state (step 308). If the event is the removal of a file or cookie, then the modified cookie or file is added to a list designated RemovedCookies list (step 306). The RemovedCookies list represents those web browser cookies which are to be removed. In addition, the modified cookie is removed from a list designated ChangedCookies if the cookie is on the ChangedCookies list (step 307), and the PPD module 1F proceeds to the wait state (step 308).

FIG. 4 is a flow diagram of a method for the protection of persistent data files during the shut down procedures of the media file management system. FIG. 4 can also be implemented by the PPD module 104, and though it is shown in FIG. 4 as protecting and securing Internet web browser cookies produced and used by the media file management system, it is also applicable to other persistent data files of the media file management system. As shown in FIG. 4, an interrupt handler is initiated when the media file management system is shutting down (step 401). In response to the system shutdown, the web browser cookie event (or other event type) handler, as described in FIG. 3, is halted (step 402). Following the halting of the web browser cookie event handler, the PPD module 1F enters a logical looping structure loop 403. In the loop 403, the PPD module 1F determines if any of the cookies listed in the RemovedCookies list are also listed in the ActiveCookies list (step 404). All cookies which are common to the two lists are removed from the ActiveCookies list (step 405). After each of the cookies listed in the RemovedCookies list is checked, the loop ends at end loop 406.

After completing loop 403, the PPD module 1F enters another logical looping structure loop 407. Loop 407 updates the records in the database module 1C representing the web browser cookies (and the other persistent data files) and iterates through the list of ChangedCookies. In the loop 407, the PPD module 1F retrieves information about the cookie currently being evaluated (step 408). The PPD module 1F determines if any of the cookies are common to both the ChangedCookies list and the ActiveCookies list (step 409). If a cookie is present in both lists, then the cookie table in the database module 1C is updated with that cookie's modification time and file contents (step 410). If the cookie is not in the ActiveCookies list, then the cookie is inserted into the database module 1C with the cookie's path, time of creation and modification, and file contents (step 411). After checking each cookie in the ChangedCookies lists, the loop 411 ends (step 412).

FIG. 5 is a flow diagram of a method for one mouse click downloading of all media files displayed in the browsing window of main window 1A. As shown in FIG. 5, the process starts when a user activates a one-click download of all media files displayed in the browsing window (step 501). In response to the one-click download, a traversable data structure of links (hereinafter link data structure) from which each media file is downloaded (step 502). A looping structure is initiated to iterate through all of the links of the link data structure (step 503). Each iteration of the loop evaluates a single link from the link data structure (hereinafter current link). First, the current link is evaluated to determine whether the link is an HTML anchor element, such as a clickable link on a web page (step 504). If the current link is an HTML anchor element, then the actual source of the media file targeted for download, if any, can be parsed from the full text of the link. Accordingly, if the current link is an HTML anchor element, the targetLink is set equal to the link.

If the current link is not an HTML anchor element, then the current link is evaluated to determine if the link is an HTML image element (step 507). If the current link is not an HTML image element, then the loop evaluates the next link in the link data structure (step 503). If the current link is an HTML image element, then the current link is evaluated to determine if the parent element of the link is an HTML anchor element (step 508). If the current link's parent is not an HTML anchor, then the loop evaluates the next link in the link data structure (step 503). If the current link's parent is an HTML anchor, then the relevant characteristics (hereinafter file traits) of the targeted media file are retrieved and targetLink is set equal to the parent link (step 509). The file traits can include, for example, the size, height, and width of the file. The file traits are compared against pre-designated minimums set by the user of the software application (step 510). If the file traits are below the minimum set by the user, then the loop evaluates the next link in the link data structure (step 503).

If the file traits meet the minimum requirements set by the user or if the current link is an HTML anchor element, the correct URL of the actual source for the targeted media file is parsed out (step 506). It is then determined if the file type of the targeted media file is supported by the media file management system (step 511). If it is not supported, then the loop evaluates the next link in the link data structure (step 503). On the other hand, if the file type is supported, then the source described in targetLink is added to the download queue (step 512). The download queue is a list of files to be downloaded via the download window of the main window 1A. If the current link is the last link in the link data structure, then the loop process ends (step 513).

FIGS. 6A and 6B are flow diagrams of methods for a single mouse click downloading of an individual media file displayed in the browsing window of main window 1A. The method of FIG. 6A is executed when the user hovers over a particular target HTML element (hereinafter target link) with the mouse input device pointer in the browsing window (hereinafter hover over action). The method of FIG. 6B is executed when the user uses the mouse input device to click on a target link in the browsing window (hereinafter mouse click action).

As shown in FIG. 6A, a mouse hover over action proceeds from the receipt of a notification that the user has moved the mouse pointer over an HTML element (step 601). It is then determined if the link representing the target link over which the mouse is hovering can be downloaded (step 602). In other words, it is determined if the link is downloadable. The determination of whether a link (hereinafter current link) is downloadable is accomplished through the processing of steps 503 to 513 of FIG. 5, as described above. As described above, this processing determines whether the link is an HTML anchor element or an HTML image element. If the current link is an HTML anchor element, then the correct URL of the actual source for the media file targeted for download is parsed from the full text of the link. If the current link is an HTML image element, the current link is evaluated to determine if the parent element of the link is an HTML anchor element, and if so, whether the file traits meet a minimum set by the user. If the current link is an HTML element or the file traits meet the minimum set by the user, then targetLink is set equal to the link and the link is downloadable.

If the target link is downloadable, then quickSaveLink is set equal to targetLink (step 604). Otherwise, quickSaveLink is cleared in (step 602), and the processing is terminated. If the target link is downloadable, a message is displayed to prompt the user to use a keyboard input, for example the shift key, along with a single mouse button input to save the target media file (step 605). Following the display of the message, the processing is terminated.

As shown in FIG. 6B, a mouse click action proceeds from the receipt of a notification of that the user has clicked the mouse pointer on an HTML element (step 606). It is then determined whether a quickSaveLink is empty or not (step 607). If it is empty, then the processing is terminated. However, if not empty, the quickSaveLink is placed into the download queue (step 608), and the quickSaveLink is cleared (step 609).

FIG. 7 is a flow diagram of a method for the encryption and storage of media files. This method can be implemented with the FED module 1D. The encryption of a file works hand-in-hand with the decryption of a file as detailed in FIG. 8. As shown in FIG. 7, the FED module 1D retrieves a database record from the database module 1C associated with the media file to be encrypted (hereinafter target file) (step 701). Relevant information for each file is stored in the database module 1C. For example, the path to a media file, the key for encryption, and the state of the media file are stored in the database module 1C.

Following the retrieval of the database record, The FED module 1D evaluates the record to determine if the file is already encrypted (step 702). If the file is already encrypted, a value of TRUE is returned (step 703), and the processing is terminated. If the file is not already encrypted, the FED module 1D evaluates the database record to determine if the target file is not currently decrypted (step 704). If the file is not currently decrypted, a value of FALSE is returned (step 705), and the processing is terminated. If not currently decrypted, then the status for the target file's record in the database module 1C is updated to reflect that the status of the target file is no longer valid or is corrupted (step 707). The FED module 1D then encrypts a portion of the target file (step 708). The size of the portion to be encrypted is set by the user of the media file management system. Following the encryption of a portion of the target file, the entire target file is written to the path specified in the database record (step 708).

The target media files are preferably named in an obfuscated way to insure casual inspection of the files will not reveal any information about the file's contents. Further, file extensions are only added to those files that have been decrypted for viewing. The consequence of this name-obfuscation method of file writing is that casual inspection of directory contents will not reveal any information about any media file associated with the media file management system.

The FED module 1D evaluates if the encryption and renaming were successful (step 709). A return of FALSE will result if either the encryption or the renaming failed (step 710). If both the file naming and the encryption were successful, then the FED module 1D updates the database record for the target file in the database module 1C (step 711), and the processing terminates with a return of TRUE (step 712).

FIG. 8 is a flow diagram of a method for the decryption of media files. Like the encryption process, the FED module 1D can be implemented to perform the decryption, which similarly works hand-in-hand with the encryption of a file as detailed in FIG. 7. As shown in FIG. 8, the FED module 1D starts the file decryption by retrieving a database record from the database module for the media file to be decrypted (hereinafter target file) (step 801). Relevant information for each file is stored in the database module 1C. For example, the relevant information can include the path to a media file, the key for encryption, and the state of the media file, as stored in the database module 1C.

Following the retrieval of the database record, the FED module 1D evaluates the record to determine if the file is already decrypted (step 802). If the file is already decrypted, a value of TRUE is returned (step 803), and the processing is terminated. If the file is not already decrypted, the FED module 1D evaluates the database record to determine if the target file is not currently encrypted (step 804). If the file is not currently encrypted, a value of FALSE is returned (step 805), and the processing is terminated. Otherwise, the FED module 1D updates the status for the target file's record in the database module 1C to reflect that the status is no longer valid or is corrupted (step 806). Subsequently, a portion of the target file is decrypted (step 807). The size of the portion to be decrypted can be set by the user of the media file management system. Following the decryption of a portion of the target file, the target file is renamed to the path and extension as specified in the database module 1C (step 808).

The media files are named in an obfuscated way to insure casual inspection of the files will not reveal any information about the file's contents. Further, file extensions are only added to those files that have been decrypted for viewing. The consequence of this name-obfuscation method of file writing is that casual inspection of directory contents will not reveal any information about any media file associated with the software application. In addition, when files are written after decryption, they are written to a temporary directory. The contents of this temporary directory are deleted by the software application during start up and also during shutdown. The deletion of the temporary directory for media files ensures that decrypted versions of the viewed files will be removed in the event of a power failure and subsequent restart of the program.

The FED module 1D evaluates if the decryption and renaming were successful (step 809). A return of FALSE will result if either the decryption or the renaming failed (step 810). If both the renaming and decryption were successful, then the FED module 1D updates the record for the target file in the database module 1C (step 811). In addition, the outputPath for the target file is set to the renamed path plus extension (812). The outputPath is a concatenation of the file path (without extension) plus the file extension. For example, if path=“C:\Temp\movie1”, and the corresponding extension=“.mpg”, then outputPath=“C:\Temp\movie1.mpg”. The extension is stored separately in order to quickly determine properties of the file which are related to the extension (and thus the file type), instead of always having to parse out the extension each time it is needed. After setting the outputPath, the processing terminates with a return value of TRUE (step 813).

FIG. 9 is a flow diagram detailing a method for the importing and encrypting of media files not present in the media file management system. This feature is useful to allow users of the media file management system to import previously obtained media files. As shown in FIG. 9, the process first reads the metadata of the file which the user is trying to associate with the media file management system (hereinafter target file) (step 901). Examples of file metadata include, for example, image size for images files and duration for a movie file. Following the reading of the metadata, a preview image of the media file is generated and displayed to the user (step 902). The target file is copied into a temporary storage area (step 903). An example of a temporary storage area would be a temporary directory on a file system. A portion of the target file is then encrypted (step 904). The size of the portion to be encrypted is set by the user of the media file management system. Following the encryption of a portion of the target file, a check is made to determine whether there was an error with the encryption (step 905). If the encryption failed, then the temporary file is removed (step 906), and a return of FALSE will result (step 907).

If the encryption was successful, then the entire newly encrypted file is moved to a specified path (step 908). In addition, a record for the newly associated file is inserted into the database module 1C (step 909). A check is made to determine whether the file was successfully added to the database module 1C (step 910). If the addition failed, then the file moved to the to the specified path is removed (step 911), and a return value of FALSE will result (step 913). However, if the database insertion was successful, then the processing with a return of TRUE (step 912).

FIGS. 10A-10C are diagrams illustrating the user actions for the one click and hover action download of a single media file (FIGS. 6A and 6B) and one click download of an entire web page's content (FIG. 5). FIG. 10A shows the browsing window of main window 1A and some media file images that the user 10B is viewing in the media file management system. The mouse input device 10A is used to manipulate the position of the mouse pointer. The user 10B positions the mouse pointer with the mouse input device 10A to create a hover over action in which the user 10B hovers the pointer over the image that the user 10B wishes to download.

As shown in FIG. 10B, once the user 10B has positioned the mouse pointer on top of the media file the user 10B wishes to download, the user 10B will click a button on the mouse input device 10A along with a keyboard input through keyboard 10C, which will accomplish a mouse click action, as described with respect to FIGS. 6A and 6B. Following the mouse click action, the media file 10E chosen by the user 10B is communicated through a communication channel 10D from the browsing window of the main window 1A to the FED Module 1D. The media file chosen by the user 10B is then encrypted and written to the database module 1C by the FED module 1D.

FIG. 10C shows the browsing window of main window 1A in which a user 10B wishes to download the entire web page's content. The user 10B manipulates the mouse input device 10A to manipulate the position of the mouse pointer to create a one click download action. The result of the one click download action is described above with respect to FIG. 5. Following the one click download action, all the media files 10E-10H selected by the user 10B are communicated through the communication channel 10D from the browsing window of main window 10A to the FED module 1D. The media files 10E-10H chosen by the user 10B are then encrypted and written to the database module 1C by the FED module 1D.

In summary, according to certain aspects of the invention, a media file management system allows a user to view media files, such as video, images, and/or sound files, in various views (e.g., thumbnail or list), to create playlists of select media files, and to categorize the media files according to content type. The media file management system can be configured with an embedded browser that enables the user to obtain new content including the ability to obtain all media objects or files present in a web page (e.g., 10 images on a page), as well as the ability to hover a mouse pointer over a media object and add the media object to the media file management system with one-click or by dragging and dropping the media object into the organizer.

The media file management application is preferably configured with various security and privacy features. For example, the media file management system encrypts each media object associated with the system, such as with a 128-bit encryption, as well as obscuring the name of the media object as stored so that the content of the media object cannot be discerned from the name. The media object can also be stored in a manner such that the file extension of the media object is separated from the name of the file so that the type of media object also cannot be discerned from the name of the file. When selecting the media object to be viewed, it is decrypted and the applicable file extension is reconnected so that the type of media object can be recognized and the media object is played or shown appropriately.

Other security and privacy features include having use of the application password protected, both at startup and when maximizing the application from a taskbar after it has been minimized. Further, the browser history when using the media file management system can also be encrypted so that it is only viewable when using system but is otherwise inaccessible and unviewable outside of the system. Similarly, any cookies, which are associated with the media file management system through browsing of various web sites, can be encrypted and stored only in the database of the media file management system so that they are unavailable and inaccessible outside of the system. Additional features include the ability to designate a panic button, which when depressed immediately closes the application, and the ability to alter the name and/or design of a desktop icon for the media so as to mask the purpose and content of the media file management system.

For viewing the media objects present in the media file management system, users can select various media objects to be placed in one or more playlists. Each playlist can be played in a specific order or randomly. For certain types of media objects, such as videos, the media file management system includes a bookmark feature that can be set at any point in a video. When playing the video, a user can skip to the bookmarked location at any time. To identify the bookmarks in a video, each bookmark can be represented by a name and/or a screenshot of the scene at which the bookmark is located.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments (which can be practiced separately or in combination) were chosen and described in order to explain the principles of the invention and as practical application(s) to enable one skilled in the art to make and use the invention in various embodiments and with various modifications suited to the particular uses contemplated. It is intended that the scope of the invention be defined by the claims appended hereto and their equivalents.

What is claimed is:

1. A method for collecting and organizing media object in a media management application operating in a computer system, comprising:
opening a browsing window in the media management application;
selecting a media object displayed in the browsing window in response to a user input;
downloading the selected media object to the media management application;
encrypting the downloaded media object and storing the encrypted media object in a database;
maintaining persistent data files based on user browsing and downloading activity; and
encrypting the persistent data files and storing the encrypted persistent data files in the database.

2. A method according to claim 1, wherein the persistent data files includes at least one of a user access history, user preferences, and an Internet web browser cookie.

3. A method according to claim 1, further comprising receiving a user input to close the media management application,
wherein the persistent data files are encrypted in response to the user input to close the media management application.

4. A method according to claim 1, further comprising:
receiving a user input to open the media management application; and
decrypting the persistent data files in response to the user input to open the media management application.

5. A method according to claim 1, further comprising determining whether the selected media object can be downloaded.

6. A method according to claim 5, wherein the step of determining whether the selected media object can be downloaded includes:
determining whether a link to the selected media object is an anchor element;
determining if a file type of the selected media object is supported by the media file management system; and
identifying the selected media object as being downloadable if the link to the selected media object is an anchor element and the file type of the selected media object is supported by the media file management system.

7. A method according to claim 5, wherein the step of determining whether the selected media object can be downloaded includes:
determining whether a link to the selected media object is an image element;
determining if a parent element of the link to the selected media object is an anchor element;
determining if file traits of the selected media object meet predetermined thresholds;
determining if a file type of the selected media object is supported by the media file management system; and
identifying the selected media object as being downloadable if the link to the selected media object is an image element, the parent element of the link to the selected media object is an anchor element, the file traits of the selected media object meet the predetermined thresholds, and the file type of the selected media object is supported by the media file management system.

8. A method according to claim 1, wherein the step of storing includes:
renaming the encrypted media object in a manner such that the name of the encrypted media object is unrelated to the content of the media object; and
removing the file extension from the name of the encrypted media object.

9. A method according to claim 8, further comprising:
receiving a request to view a media object stored in the database of the media management application;
adding the applicable file extension to the media object requested to be viewed in response to the request;
decrypting the media object requested to be viewed; and
displaying the decrypted media object in a viewing window of the media management application.

10. A method according to claim 1, further comprising:
minimizing the media management application to a task bar in response to a user input;
receiving a request to maximize the media management application from the taskbar;
prompting the user to enter at least a password in response to the request; and
maximizing the media management application from the taskbar only if the password is correct.

11. A method according to claim 1, further comprising:
displaying an icon on a computer desktop used to activate the media management application, wherein a name for the icon is unrelated to the operation of the media management application and is unrelated to a content of media objects associated with the media management application;
receiving a selection of the icon;
prompting the user to enter at least a password in response to the selection; and
activating the media management application only if the password is correct.

12. A method according to claim 1, further comprising, wherein the media objects and persistent data files stored in the database are inaccessible to any application other than the media management application.
